(19) United States
(12) Patent Application Publication
(10) Pub. No.: US 2025/0289212 A1
(43) Pub. Date: Sep. 18, 2025

(54) A METHOD FOR PRODUCING A LAMINATE, AND A LAMINATE

(71) Applicant: Stora Enso OYJ, Helsinki (FI)

(72) Inventors: Otto Nylén, Helsinki (FI); Kaj Backfolk, Lappeenranta (FI)

(73) Assignee: Stora Enso OYJ, Helsinki (FI)

(21) Appl. No.: 18/872,949

(22) PCT Filed: Jun. 29, 2023
(86) PCT No.: PCT/IB2023/056770

§ 371 Date: Dec. 9, 2024

(30) Foreign Application Priority Data
Jul. 8, 2022 (SE) 2230229-3

(51) Int. Cl. B32B 37/12; B32B 7/12; B32B 29/02; B32B 38/00; B32B 38/16; D21H 27/32

(52) U.S. Cl. CPC B32B 37/12; B32B 7/12; B32B 29/02; B32B 38/164; D21H 27/32; B32B 2037/1276; B32B 2038/166; B32B 2250/02; B32B 2262/062; B32B 2307/54; B32B 2307/718; B32B 2317/12; B32B 2317/18; B32B 2553/00

(57) ABSTRACT

The present invention relates to a method for producing a laminate comprising a paper or paperboard substrate and a microfibrillated cellulose (MFC) film. A first web comprising a paper or paperboard substrate is provided. A second web of an MFC film is provided, wherein the MFC film has: a) a content of MFC of 50-100 weight-% based on total dry weight; b) a moisture content of 5-20 weight-%, c) a ratio of a machine direction tensile index and a cross direction tensile index of 0.8-1.4. The first web and the second web are joined using at least one adhesive layer provided between the webs so as to form the laminate. The MFC film of the laminate is further dried to a moisture content of less than 4 weight-%. The invention relates also to a laminate and a packaging material comprising the laminate.

### TECHNICAL FIELD

The present disclosure relates to a method for producing a laminate comprising a paper or paperboard substrate and a barrier film, wherein the barrier film is a microfibrillated cellulose (MFC) film. In addition, the present disclosure relates to a laminate comprising a paper or paperboard substrate and an MFC film, a packaging material comprising the laminate and use of the laminate in a packaging material.

### BACKGROUND

Oxygen, grease, water vapor and/or aroma barrier properties are required in many uses of paper and paperboard packaging. However, paper and paperboard substrates do not have these properties inherently. Most commonly barrier characteristics of paper and paperboard substrates are created by adding one or more barrier coatings and/or laminated barrier layers which are based on plastics or other non-renewable materials. The disadvantage with these coatings and barrier layers is their non-renewable raw material basis that can increase the carbon dioxide footprint of the material as well as make the otherwise biodegradable paper or paperboard non-biodegradable and in some cases non-recyclable. Furthermore, in order to improve a barrier comprising barrier coatings and/or laminated barrier layers based on plastics or other non-renewable materials, it is usually needed to increase the amount of used polymer and/or various polymer layers. Hence, the possibility to disintegrate and recycle fiber fraction(s) of paper or paperboard substrates provided with such improved barriers becomes then even more difficult.

More recently, microfibrillated cellulose (MFC) films have been developed, in which cellulosic fibrils, provided by fibrillation of cellulose fibers, have been suspended e.g., in water and thereafter re-organized and re-bonded together to form a dense film with barrier properties, such as oxygen, aroma and grease barrier properties. MFC films are recyclable and biodegradable as well as based on renewable raw material.

Laminates comprising a paper or paperboard substrate and an MFC film have been disclosed for use in e.g., packaging materials or applications, such as liquid or food packaging materials. Such laminates can be manufactured almost entirely from biobased materials, and preferably from cellulose-based materials, thereby facilitating re-pulping and recycling of used packaging materials comprising the laminate and enabling an aluminum foil free laminate structure for e.g., aseptic packaging. However, sometimes such laminates are further provided with an outermost polymer layer on one side or on both sides. The outermost polymer layers preferably provide liquid barrier properties and mechanical protection for the laminate surface. Preferably, the outermost polymer layers are also heat-sealable. Sometimes the outermost polymer layers are also used for decorative purposes, such as for printing or protection of printing.

In order to provide a paper substrate or a paperboard substrate with an MFC film, a free-standing MFC film may be produced from an MFC suspension and thereafter laminated with the paper substrate or the paperboard substrate.

One approach to produce a free-standing MFC film from an MFC suspension is to use a film casting method, i.e., forming a film by casting the MFC suspension on a non-porous support such as a plastic or metal support and then dewatering and/or drying the film. Casting methods have been shown to produce MFC films with very smooth surfaces with good barrier properties, such as oxygen barrier properties and/or water vapor barrier properties.

Another approach to produce a free-standing MFC film is to use a wet laid technique, i.e., to apply a layer of an MFC suspension on a dewatering wire or membrane and dewater it by vacuum, gravitation, capillary dewatering, press dewatering or a combination of these on the wire or membrane followed by drying or liquid evaporation. However, one disadvantage with this approach is that film additives that are either dissolved or emulsified in the aqueous phase of the MFC suspension are removed from the MFC layer to a large extent during the dewatering. Retention and/or flocculation agents may thus be needed to counteract removal of film additives. However, retention and/or flocculation agents usually have a negative impact on barrier properties and do not guarantee complete retention. Also, this approach has limitations for the used MFC type, as very fine MFC cannot be used as it can also pass or penetrate through the wire or clog the wire or membrane. Also, other very small dissolved or solid particles dispersed in aqueous phase of MFC suspension, such as mineral nanofillers, have tendency to pass and penetrate through the wire or membrane in dewatering step.

Commonly, free-standing MFC films, such as MFC films produced by a casting method or a wet-laid method, have low resilience (i.e., high brittleness). This may lead to converting difficulties, such as web handling difficulties, in lamination processes, e.g., when such an MFC film is unwound from a reel and conveyed to and/or in a lamination process for lamination with a paper substrate or paperboard substrate. Thus, the brittleness may lead to runnability problems and web breaks or defects such as torn edges, cracks and wrinkles in such MFC films when used for lamination.

One approach to mitigate the difficulties with the brittleness of an MFC film is to use humectants in the MFC film. However, humectants, in particular high amounts of humectants, change the relative moisture content of the MFC film which can then cause further problems if laminating the MFC film between two polymer layers, such as between a tie layer (which is used for laminating the MFC film to a paper or paperboard substrate) and a liquid barrier layer (i.e., an outermost polymer layer). Entrapped moisture or potentially VOC (volatile organic compounds) might then cause delamination problems or blistering. Higher amount of entrapped moisture gives naturally a higher risk for post-delamination. Thus, the use of a high concentration of humectants increases this risk even more. Also, elevated temperatures in post-processing, such as printing or converting of the laminate, shaping and sealing of a final product (e.g., a packaging product) comprising the laminate, or filling and storing of products in the final product, may lead to a higher risk for post-delamination.

Thus, there is still room for improvements of methods for producing laminates comprising a paper or paperboard substrate and a barrier film, wherein the barrier film is an MFC film.

### DESCRIPTION OF THE INVENTION

It is an object of the present invention to provide an improved method of producing a laminate comprising a paper or paperboard substrate and a barrier film, wherein the barrier film is an MFC film, which method reduces the difficulties with brittleness of MFC films in web handling in connection with lamination to a paper or paperboard substrate and which method eliminates or alleviates at least some of the disadvantages of the prior art methods.

The above-mentioned object, as well as other objects as will be realized by the skilled person in the light of the present disclosure, is achieved by the various aspects of the present disclosure.

The invention is defined by the appended independent claims. Embodiments are set forth in the appended dependent claims and in the following description.

According to a first aspect illustrated herein, there is provided a method for producing a laminate comprising a paper or paperboard substrate and a microfibrillated cellulose (MFC) film, wherein the method comprises the steps of:
providing a first web comprising a paper or paperboard substrate;
providing a second web of an MFC film, wherein the MFC film has: a) a content of MFC of between 50 and 100 weight-% based on total dry weight; b) a moisture content of 5-20 weight-%, preferably 5-15 weight-%, and c) a ratio of a machine direction tensile index and a cross direction tensile index of 0.8-1.4, preferably 0.8-1.2, most preferably 0.9-1.1;
joining said first web and said second web using at least one adhesive layer provided between said first web and said second web so as to form said laminate, and
further drying of said MFC film of said laminate to a moisture content of less than 4 weight-%, preferably less than 2 weight-%, most preferably less than 1.5 weight-%.

Thus, the method of the first aspect provides a laminate comprising a paper or paperboard substrate and a microfibrillated cellulose (MFC) film, which is a barrier film. Accordingly, the laminate is a barrier laminate.

Commonly, free-standing MFC films, such as free-standing MFC films produced by a casting method or a wet-laid method, have low resilience (i.e., high brittleness). This may lead to converting difficulties, such as web handling difficulties, in lamination processes. For example, the web handling difficulties may comprise difficulties when such an MFC film is conveyed (e.g., after being unwound from a reel) to and/or in a lamination process for lamination with a substrate, such as a paper substrate or paperboard substrate. Thus, the brittleness may lead to runnability problems and web breaks or defects such as torn edges and cracks in such MFC films when used for lamination.

The common difficulties with brittleness of free-standing MFC films in web handling in connection with lamination are at least partly due to the fact that free-standing MFC films are produced to have a low moisture content, i.e., dried to a low moisture content, commonly below 5 weight-%, such as 1.5-4.5 weight-%. In fact, there is a desire to produce free-standing MFC films with a low moisture content, since a low moisture content of the MFC films in laminates is desired in order to avoid problems with moisture escaping or evaporating from the MFC films during for example converting process steps with elevated temperatures causing delamination. Furthermore, in later stages when the laminate is used to form a package, sealing of the seams in the package may evaporate water from moist MFC film and cause delamination. In addition, the barrier properties, such as oxygen barrier and water vapor barrier, of MFC films may be lower when the moisture content in the films is high, and therefore low moisture content is preferred for barrier properties. Also, MFC films are produced with a low moisture content in order to ensure sufficient film formation and cross-linking during production of the MFC film. In addition, MFC films are produced with a low moisture content in order to promote the dimensional stability of the produced MFC film. However, as mentioned above, when MFC films with low moisture contents are used in lamination processes, the brittleness may lead to runnability problems and web breaks or defects. Also, a disadvantage with MFC films with low moisture content is low strain at break and higher strain rate sensitivity.

With the method according to the first aspect, it is possible to essentially reduce or mitigate difficulties with brittleness of a free-standing MFC film in lamination processes, in particular in steps of handling of a web of the MFC film such as unwinding from a reel and conveying, for lamination to a paper or paperboard substrate, at the same time as the dimensional stability of the MFC film is promoted and a low moisture content is provided in the MFC film of the formed laminate. Also, with the method according to the first aspect, it is possible to essentially reduce or mitigate difficulties with brittleness of a free-standing MFC film in lamination processes without using humectants or at least not using high amounts of humectants. More specifically, by using the specified MFC film for the lamination having a content of MFC of between 50 and 100 weight-% based on total dry weight, a moisture content of 5-20 weight-% and a ratio of a machine direction tensile index and a cross direction tensile index of 0.8-1.4 and by including an extra drying step for drying of the MFC film of the laminate, i.e., after joining of the MFC film and the paper or paperboard substrate using at least one adhesive layer to form the laminate, to a moisture content of less than 4 weight-%, the difficulties with brittleness of the MFC film during the web handling in the lamination process is essentially reduced or mitigated at the same time as the dimensional stability of the MFC film is promoted and a low moisture content is provided in the MFC film of the formed laminate.

By using the specified MFC film with a moisture content of 5-20 weight-% and by including an extra drying step of the MFC film after the joining, it is possible to reduce the brittleness problems during handling of the web of the MFC film in the lamination process, i.e., before the joining of the MFC film with the paper or paperboard substrate, since the MFC film has a moisture content which may mitigate brittleness problems before the joining at the same time as a lower moisture content of the MFC film in the laminate is provided after the joining. Also, by the MFC film having a ratio of a machine direction tensile index and cross direction tensile index of 0.8-1.4, the dimensional stability of the MFC film is promoted during web handling of the MFC film before joining even though the moisture content is 5-20 weight-%.

Paper generally refers to a material manufactured in thin sheets from the pulp of wood or other fibrous substances comprising cellulose fibers, used for writing, drawing, or printing on, or as packaging material. Paper can either be bleached or unbleached, coated or uncoated, and produced in a variety of thicknesses, depending on the end use requirements. Paper may be a single ply material, or a multiply material comprised of two or more plies.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements. Paperboard may be a single ply material, or a multiply material comprised of two or more plies. A common type of multiply paperboard is comprised of a lower density mid-ply (also sometimes referred to as “bulk ply”) sandwiched between two higher density outer plies. The lower density mid-ply may typically have a density below 750 kg/m³, preferably below 700, below 650, below 600, below 550, below 500, below 450, below 400 or below 350 kg/m³. The higher density outer plies typically have a density at least 100 kg/m³ higher than the mid-ply, preferably at least 200 kg/m³ higher than the mid-ply.

The paper or paperboard used as a substrate in accordance with the present disclosure can be made from pulp, including pulp from virgin fiber, e.g., mechanical, semi-chemical, chemical and/or thermomechanical pulps. It can also be made from broke or recycled paper or paperboard. The paper or paperboard used as a substrate in accordance with the present disclosure is prepared using methods known in the art.

In some embodiments, the paper or paperboard substrate comprises at least 10% recycled material, such as at least 20% or at least 40% or at least 50% or at least 60% or at least 70% recycled material, which can be either pre-or post-consumer grade.

The paper substrate used in the method of the first aspect has preferably a grammage in the range of 10-200 g/m², more preferably in the range of 20-100 g/m². Unless otherwise stated, the grammage is determined according to the standard ISO 536.

The paperboard substrate used in the method of the first aspect has preferably a grammage in the range of 120-600 g/m² or 120-450 g/m², more preferably in the range of 200-500 g/m² or 180-380 g/m². Unless otherwise stated, the grammage is determined according to the standard ISO 536.

The paper or paperboard substrate may be a single ply paper or paperboard or a multiply paper or paperboard. In some embodiments, the paperboard substrate is a multiply paperboard. In some embodiments, the paperboard substrate is a multiply paperboard comprised of two or more plies. In some embodiments, the paperboard substrate is a multiply paperboard comprised of three or more plies. In some embodiments, the paperboard substrate is a multiply paperboard comprised of a lower density mid-ply sandwiched between two higher density outer plies.

In some embodiments, the paperboard substrate is a foam formed paperboard. In some embodiments wherein the paperboard substrate is a multiply paperboard, at least one of the plies, preferably a mid-ply, is foam formed. In some embodiments wherein the paperboard substrate is a multiply paperboard, at least one of the plies, preferably a mid-ply, is a bulky ply.

The paper or paperboard substrate is optionally coated, such as mineral coated, to improve smoothness and printability. Such mineral coating may be provided on one or both sides of the substrate and is then a part of the substrate in the context of the present disclosure. The paper or paperboard substrate may be subjected to surface sizing or surface treatment on at least one side of the substrate. Such surface sizing or surface treatment is then part of the paper or paperboard substrate in the context of the present disclosure. Preferably, a surface sizing composition used for surface sizing comprises starch or a starch derivative.

The term film as used herein refers generally to a thin continuous sheet formed material, such as a thin substrate with good gas, aroma or grease or oil barrier properties, e.g., oxygen barrier properties and/or water vapor barrier properties. Depending on the composition of the MFC suspension from which it is formed, the MFC film can also be considered as a thin paper (e.g., nanopaper or micropaper) or even as a membrane.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by oxidation, for example 2,2′,6,6′-tetramethylpiperidin-N-oxyl (TEMPO) mediated oxidation), or quaternary ammonium (cationic cellulose). After being modified or oxidized in one of the above-described methods, it is easier to disintegrate the fibers into MFC.

MFC can be produced from wood cellulose fibers, both from hardwood and/or softwood fibers. It can also be made from microbial sources, agricultural fibers such as wheat straw pulp, bamboo, bagasse, or other non-wood fiber sources. It can be made from pulp, including pulp from virgin fiber, e.g., mechanical, chemical and/or thermomechanical pulps. It can also be made from broke or recycled paper.

As mentioned above, the MFC film of the second web comprises between 50 weight-% to 100 weight-% MFC based on total dry weight. In some embodiments, the MFC film comprises between 60 weight-% to 100 weight-%, preferably between 70 weight-% to 100 weight-%, more preferably between 80 weight-% to 100 weight-% of microfibrillated cellulose based on total dry weight, wherein this relates to the amount of microfibrillated cellulose in the film per se.

In some embodiments, the provided MFC film (i.e., the provided MFC film having a moisture content of 5-20 weight-%) of the second web has a grammage of 4-80 g/m², preferably 10-60 g/m² or 15-50 g/m² or 18-45 g/m² or 20-40 g/m², as measured according to ISO 536:2019. Particular grammages of the provided MFC film may be 4-10 g/m², 10-20 g/m², 20-30 g/m², 30-40 g/m², 40-50 g/m², 50-60 g/m², 60-70 g/m² or 70-80 g/m².

In some embodiments, the density of the provided MFC film of the second web is 700-1400 kg/m³, such as 800-1300 kg/m³ or 850-1200 kg/m³, as measured according to ISO 534:2011.

In some embodiments, an average film thickness of the provided MFC film of the second web is 5-60 μm, preferably 10-50 μm, 15-45 μm or 20-40 μm. Particular average film thicknesses may be 5-10 μm, 10-15 μm, 15-20 μm, 20-25 μm, 25-30 μm, 30-35 μm, 35-40 μm, 40-45 μm, 45-50 μm, 50-55 μm or 55-60 μm. The average film thickness may be defined as an average thickness of the film across the entire width. Thickness of the MFC film may be measured using, as non-limiting examples, white light interferometry, laser profilometry, or optically by cutting a sample in cross-machine directional line (either cast in resin or not) and microscopic imaging (e.g., scanning electron microscopy or other applicable method) of the cut section in thickness direction.

In some embodiments, a width of the provided MFC film of the second web is 0.3-4 m, preferably 0.5-4 m, 1-4 m or 2-4 m.

In some embodiments, the provided MFC film of the second web has an oxygen transmission rate (OTR), measured according to the standard ASTM F1927—20 at 50% relative humidity and 23° C., of less than 50 cc/m²/24 h, preferably less than 20 cc/m²/24 h, most preferably less than 10 cc/m²/24 h.

In some embodiments, the provided MFC film of the second web has a water vapor transmission rate (WVTR), measured according to the standard ASTM F1249—20 at 50% relative humidity and 23° C., of less than 100 g/m²/24 h, preferably less than 50 g/m²/24 h, and more preferably less than 20 g/m²/24 h.

In some embodiments, the provided MFC film of the second web has a KIT value of at least 10, preferably 12, as measured according to standard ISO 16532-2.

In some embodiments, the provided MFC film of the second web has less than 10 pinholes/m², most preferably less than 6 pinholes/m².

The MFC of the MFC film may comprise one or more fractions of MFC. In some embodiments, the MFC of the MFC film comprises one fraction of MFC of a fine grade. In some embodiments, the MFC of the MFC film comprises two or more fractions of MFC of different fine grades. In some embodiments, the MFC of the MFC film comprises one fraction of a fine grade and one fraction of a coarse grade, wherein the coarse grade for example may be an additive. Coarse MFC in this case has typically a Schopper-Riegler value of 80-100 SR°, such as 80-99 SR° or 90-99 SR° or 95-99 SR°, whereas fine MFC is fibrillated to a Schopper-Riegler value above the measurement range (theoretical value about or above 100 SR°) as determined by standard ISO 5267-1. In some embodiments, the fine grade MFC is chemically derivatized, such as carboxymethylated MFC.

The MFC film may in addition to MFC comprise any conventional paper making additives or chemicals such as film-forming agents, dispersants, fillers, pigments, wet strength chemicals, cross-linkers, plasticizers, softeners, humectants, adhesion primers, wetting agents, biocides, colorants, de-foaming chemicals, hydrophobizing chemicals such as alkyl ketene dimer (AKD), alkenyl succinic anhydride (ASA), waxes, rosin resins, mineral additives (fillers) such as bentonite, kaolin, talcum, mica, montmorillonite, organoclays, graphene and graphene oxide, stearate, starch, silica, precipitated calcium carbonate, cationic polysaccharide, rheology modifiers, etc. These additives or chemicals may thus be process chemicals or film performance chemicals added to provide the end product film with specific properties and/or to facilitate production of the film. In some embodiments, the MFC film comprises at least one further polymer that can form a film and/or improve binding between cellulose fibrils. Typical examples of such polymers are natural gums or polysaccharides or derivatives thereof, such as carboxymethylated cellulose (CMC), hemicellulose, starch, or polyvinyl alcohol (PVOH) or derivatives or analogues thereof. In some embodiments, the MFC film comprises at least one additive selected from the group of: PVOH and derivatives or analogues thereof, polysaccharides such as starch and CMC, sorbitol and polyethylene glycol.

The PVOH may be a single type of PVOH, or it can comprise a mixture of two or more types of PVOH, differing, e.g., in degree of hydrolysis or viscosity. The PVOH may for example have a degree of hydrolysis in the range of 80-99 mol %, preferably in the range of 88-99 mol %.

In some embodiments, the MFC film comprises no more than 50 weight-%, such as no more than 35 weight-% or no more than 30 weight-% or no more than 25 weight-% or no more than 20 weight-% of additives, based on total dry weight of the MFC film. For example, the MFC film may comprise 1-50 weight-% or 1-35 weight-% or 1-30 weight-% or 1-25 weight-% or 1-20 weight-% of additives, based on total dry weight of the MFC film.

In some embodiments, the MFC film comprises 0-30 weight-% or 0.5-20 weight-% or 3-15 weight-% of of one or more humectants and/or plasticizing agents based on total dry weight, such as a sugar alcohol (e.g., sorbitol), glycol or other polyol.

In some embodiments, the MFC film comprises up to 20 weight-% of mineral filler (regular filler or nanofiller), such as bentonite, kaolin, talcum, mica, montmorillonite, organoclays, graphene, graphene oxide or a combination thereof.

In some embodiments, the MFC film comprises up to 30 weight-% of nanocrystalline and/or cellulose derivatives, based on total dry weight.

The MFC film can be a single or multilayer film, or single or multilayer ply. Thus, in some embodiments the MFC film comprises a single film layer or two or more film layers on top of each other.

In some embodiments, the MFC film comprises one or more further cellulose pulp fractions in addition to MFC, such as e.g., a cellulose pulp fraction having a Schopper-Riegler value of ≤70 SR°, such as 15-70 SR° or 25-60 SR° as determined by standard ISO 5267-1 and/or a further fraction of normal cellulose fibers and/or lignocellulose fibers.

The MFC film is preferably formed from an MFC suspension, preferably an aqueous MFC suspension (i.e., including water as suspension medium), comprising MFC and optional additive(s) and/or chemical(s) and/or further cellulose pulp fractions as defined above. The MFC suspension is preferably formed into a wet MFC film by casting, using a known casting tehcnique, on a non-porous support, such as a metal belt, in particular a steel belt, a polymer belt or a polymer coated belt. The non-porous support is typically an endless belt. Preferably, the wet MFC film is dewatered and/or dried on the non-porous support using methods known in the art to provide the MFC film having a moisture content of 5-20 weight-%. After peeling off the MFC film from the non-porous support, a web of the MFC film having a moisture content of 5-20 weight-% is provided.

The term “casting”, when utilized in film-forming, is a known term designating methods wherein a suspension is deposited by means of contact or non-contact deposition and levelling methods on a support, typically an endless belt, to form a wet web. Examples of such a deposition and levelling method are curtain coating/application, slot die casting, or dosing the MFC suspension with spray or similar device and leveling with a doctor-blade or rod.

As mentioned above, the MFC film used in the method of the first aspect, i.e., the MFC film of the second web provided to the lamination process, has a moisture content of 5-20 weight-%, preferably 5-15 weight-% or 6-15 weight-% or 6-14 weight-% or 7-13 weight-%. The moisture content of the MFC film provided to the lamination process may, for example, be determined by determining dry content according to the standard ISO 638 and calculating moisture content or by a spectroscopic method. Alternatively, the moisture content may be determined by using devices or instruments used for determining the dry content. The moisture content may be measured under ambient conditions. The specified moisture content of the MFC film implies that the MFC film has a ductility suitable for handling of the MFC film before joining with the first web to form a laminate, i.e., suitable for unwinding and web handling of the second web of the MFC film during conveying to the joining with the first web, so that difficulties with brittleness of the MFC film are mitigated.

The ductility of the MFC film may be described by the tensile strength and the strain-at-break of the MFC film. In some embodiments, the MFC film has a tensile index in the machine direction of at least 20 Nm/g, preferably at least 30 Nm/g or at least 40 Nm/g. In some embodiments, the MFC film has a strain at break in the machine direction of at least 1.5%, such as 2-20% or 3-15%.

Also, as mentioned above, the MFC film used in the method of the first aspect has a ratio of a machine direction (MD) tensile index and a cross direction (CD) tensile index of 0.8-1.4, preferably 0.8-1.2, most preferably 0.9-1.1. This implies that the microfibrils have no, or essentially no, orientation and thereby contributes to a high dimensional stability (low hygroexpansion) of the MFC film. The specified MD/CD ratio of tensile index can be obtained during production of the MFC film by, for example, producing the MFC film with a casting technique on a non-porous casting support and having no speed difference between the MFC suspension flowing out of a casting unit and the casting support on to which the MFC is casted in order to form a wet MFC film.

The tensile index in the machine direction, the strain at break and the MD/CD ratio of tensile index are measured with vertical tensile tester, such as a vertical tensile tester by Zwick, according to standard ISO 1924-3 but with a few modifications according to the following: Test span (distance between clamps): 20 mm (in ISO 1924-3 100 mm); Constant rate of elongation: 2 mm/min (in ISO 1924-3 100 mm/min); Sample width 15 mm (in accordance with ISO 1924-3); Sample length: 55 mm (ISO 1924-3 defines that it must just be long enough to be clamped); Load cell: 0.5 kN.

The dimensional stability of the MFC film used in the first aspect of the method may be further promoted by producing the MFC film by a casting techique on a non-porous casting support and using restrained dewatering and/or drying by maintaining the produced MFC film in contact with the non-porous casting support until it has reached a moisture content of 5-20 weight-% (i.e., maintaining the produced MFC film in contact with the non-porous casting support during dewatering and/or drying to a moisture content of 5-20 weight-%).

In some embodiments, the MFC film comprises at least one cross-linking chemical and/or at least one other chemical occupying free hydroxyl groups that bind water. These chemicals contribute to reduction of the hygroexpansivity of the MFC film. Examples of such chemicals are citric acid, glyoxal, ammonium zirconium carbonate, urea formaldehyde, melamine formaldehyde resins, metallic sats, zirchonium chelates, reactive starches such as dialdehyde starch, and amino resins.

As mentioned above, the first web comprising the paper or paperboard substrate and the second web of the MFC film are joined using at least one adhesive layer (i.e., tie layer) provided between the first web and the second web so as to form the laminate. The joining may be performed in a lamination station, which may comprise one or more lamination nips, such as pressure roller nips. Thus, the first and second webs may be joined and laminated in a lamination station comprising one or more lamination nips, wherein the first and second webs are pressed together in the one or more lamination nips with the at least one adhesive layer located between the first and second webs. In some embodiments, the lamination nip is formed between two rolls of which at least one can be chilled. In some embodiments, the lamination nip is formed between chilled roll and nip roll or pressure roll which is not temperature controlled. In some embodiments, the nip roll or pressure roll can be a heated roll.

The adhesive layer may comprise any suitable adhesive commonly used in paper or paperboard based packaging laminates in general or adhesives used in liquid or food packaging laminate in particular. Many different types of adhesives and adhesive coating methods may be used with the invention.

Typically, the adhesive layer will comprise one or more adhesive polymers. The adhesive layer may be comprised entirely of the one or more adhesive polymers, or it may also further comprise other additives for improving the properties of the adhesive layer.

In some embodiments, the adhesive layer comprises at least 50 weight-% of an adhesive polymer or mixture of adhesive polymers based on dry weight.

In some embodiments, the adhesive layer comprises or consists of one or more adhesive polymers selected from the group consisting of polyolefins, polyesters, polyurethanes, and acrylic copolymers. In some embodiments, the adhesive layer comprises or consists of one or more adhesive polymers selected from the group consisting of polyolefins and polyesters. In some embodiments, the adhesive layer comprises or consists of one or more of polypropylene and polyethylene, such as low density polyethylene (LDPE or LLDPE), medium density polyethylene (MDPE) or high density polyethylene (HDPE). In some embodiments, the adhesive layer comprises or consists of a component selected from adhesive thermoplastic polymers, such as modified polyolefins, which are mostly based on LDPE or LLDPE co-polymers or, graft co-polymers with functional-group containing monomer units, such as carboxylic or glycidyl functional groups, e.g., (meth)acrylic acid monomers or maleic anhydride (MAH) monomers, (i.e., ethylene acrylic acid copolymer (EAA) or ethylene methacrylic acid copolymer (EMAA)), ethylene-glycidyl(meth)acrylate copolymer (EG(M)A) or MAH-grafted polyethylene (MAHg-PE). Another example of such modified polymers or adhesive polymers are so called ionomers or ionomer polymers. Preferably, the modified polyolefin is an ethylene acrylic acid copolymer (EAA) or an ethylene methacrylic acid copolymer (EMAA).

In some embodiments, the adhesive layer comprises at least 50 weight-% of a water-soluble polymer or mixture of water-soluble polymers based on dry weight. The water-soluble polymer of the adhesive layer is soluble in cold water or soluble in hot water, e.g., at a temperature below 100° C. or even above 100° C., for a given period of time. In some embodiments, the water-soluble polymer is selected from the group consisting of a polyvinyl alcohol (PVOH) or derivatives or analogues thereof, a carboxymethyl cellulose (CMC), a starch, an alginate, and a hemicellulose, preferably a PVOH.

The adhesive layer may be applied by any suitable method known in the art. The adhesive layer may for example be applied as a solution or dispersion in an aqueous or organic solvent carrier using liquid coating methods known in the art or in melt form using extrusion coating. Extrusion coating is a process by which a molten plastic material is applied to a substrate to form a very thin, smooth, and uniform layer. In embodiments in which the adhesive layer comprises one or more adhesive polymers selected from the group consisting of polyolefins, polyesters, polyurethanes, and acrylic copolymers, extrusion coating is preferably utilized for application of the adhesive layer.

In embodiments in which the adhesive layer comprises a water-soluble polymer, the adhesive layer may be formed by means of a liquid film coating process, i.e., in the form of a solution or dispersion which, on application, is spread out to a thin, uniform layer on the substrate and thereafter dried. The adhesive layer can be applied by contact or non-contact coating methods.

In some embodiments, at least one adhesive layer is applied in the form of a foam. Foam coating is advantageous as it allows for film forming at higher solids content and lower water content compared to a non-foamed coating. The lower water content of a foam coating also reduces the problems with rewetting of the barrier substrate. The foam may be formed using a polymeric or non-polymeric foaming agent. Examples of polymeric foaming agents include PVOH, hydrophobically modified starch, and hydrophobically modified ethyl hydroxyethyl cellulose.

In some embodiments, the adhesive layer further comprises a crosslinking agent capable of crosslinking the water-soluble polymer. Crosslinking improves the water vapor barrier properties of the adhesive layer. Suitable crosslinking agents include, but are not limited to polyfunctional organic acids or aldehydes, such as citric acid, glyoxal, and glutaraldehyde. In some embodiments, the crosslinking agent is an organic acid, and more preferably citric acid. The concentration of the crosslinking agent may for example be 1-20 weight-%, preferably 1-15 weight-%, based on the dry weight of the adhesive layer.

In some embodiments, the adhesive layer comprises PVOH and citric acid. Crosslinking of the PVOH with citric acid improves the water vapor barrier properties of the adhesive layer.

In some embodiments, the adhesive layer comprises one or more additional polymer(s) in a total amount of 0-50 weight-% based on dry weight.

In some embodiments, the adhesive layer further comprises up to 50 weight-% of microfibrillated cellulose (MFC), nanocrystalline cellulose, a chemically modified cellulose derivative such as sodium carboxymethyl cellulose, hydroxypropyl cellulose, ethyl hydroxyethyl cellulose, cellulose acetate, hydroxyethyl cellulose, a hemicellulose, or a combination thereof, based on dry weight.

In some embodiments, one adhesive layer is provided between the first web and the second web so as to form the laminate. In some embodiments, two or more adhesive layers are provided between the first web and the second web so as to form the laminate. The total coat weight of the one or more adhesive layers may generally be in the range of 1-20 g/m². In some embodiments, the total coat weight of the one or more adhesive layers is in the range of 2-15 g/m², more preferably in the range of 3-12 g/m².

In some embodiments, at least one adhesive layer is provided on a surface of the first web before the joining with the second web of the MFC film. Thus, in these embodiments, at least one adhesive layer is provided on the surface of the first web, and the first web is joined in the joining step with the second web of the MFC film by means of the adhesive layer(s) provided between the first web and the second web after joining. The adhesive layer(s) may be provided on the surface of the first web by extrusion coating. In these embodiments the joining may comprise joining the first web with the second web using the adhesive layer(s) provided between the first web and the second web in a lamination station comprising at least one lamination nip.

In some embodiments, at least one adhesive layer is provided on a surface of the the MFC film of the second web before the joining with the first web. Thus, in these embodiments, at least one adhesive layer is provided on the surface of the MFC film, and the first web is joined in the joining step with the MFC film by means of the adhesive layer(s) provided between the first web and the MFC film after joining. The adhesive layer(s) may be provided on the surface of the MFC film by extrusion coating. In these embodiments the joining may comprise joining the first web with the second web using the adhesive layer(s) provided between the first web and the second web in a lamination station comprising at least one lamination nip. In these embodiments, it is particularly advantageous to utilize a water-free adhesive or a water less adhesive, such as a foamed adhesive.

In some embodiments, the joining comprises joining the first web and the second web in a lamination station comprising a lamination nip, wherein at least one adhesive layer is provided between the first web and the second web in the lamination nip by forming the adhesive layer in the lamination nip between the first web and the second web, e.g., by feeding or pouring the composition or components used for forming the adhesive layer into the lamination nip. The adhesive may be extruded into the lamination nip.

In embodiments in which more than one adhesive layer is utilized for joining the first web and the second web, all adhesive layers may be provided on the first web or be provided on the second web or be formed and provided in a lamination nip between the first web and the second web by pouring. Alternatively, in embodiments in which more than one adhesive layer is utilized for joining the first web and the second web, one or more adhesive layer may be provided on the first web and/or one or more adhesive layer may be provided on the second web and/or one or more adhesive layer may be formed and provided in a lamination nip between the first web and the second web.

In some embodiments, the second web is guided via at least one spreading roll (also denoted as spreader roll), preferably via at least one spreading roll and thereafter via an arrangement comprising a supporting member and an opposite web stabilizing unit (i.e., the second web is guided between the supporting member and the opposite web stabilizing unit), before the joining according to the method of the first aspect. In these embodiments, wrinkling, curl and/or air entrance in the joining may be prevented or essentially reduced. The supporting member and opposite web stabilizing unit may be mechanical contact devices (flat/cylindrical) or non-contact devices (pneumatic levitation). Any known suitable spreading roll may be utilized which provides a spreading action of the second web.

As mentioned above, the MFC film of the laminate is further dried to a moisture content of less than 4 weight-%, preferably less than 2 weight-%, most preferably less than 1.5 weight-% or less than 1 weight-%. The further drying of the MFC film of the laminate to a moisture content of less than 4 weight-% may be selected from the group of: contact drying, infrared (IR) drying, near infrared (NIR) drying, microwave (MW) drying, ultraviolet (UV) drying, electron beam (EB) drying, hot gas impingement drying such as hot air impingement drying, other type of radiation drying and a combination thereof.

In some embodiments, the further drying of the MFC film of the laminate is radiation drying selected from the group of: IR drying, NIR drying, MW drying, UV drying, EB drying and a combination thereof.

In some embodiments, the further drying of the MFC film of the laminate is selected from the group of: IR drying, UV drying, EB drying and a combination thereof.

By using radiation drying, in particular IR drying, UV drying and/or EB drying, a sterilization effect, i.e., killing and/or deactivaton of potential microbes and/or enzymes may be achieved, and/or a cross-linking effect may be achieved in addition to the drying effect. Also, the further drying may imply that the viscosity of the adhesive layer is changed through depolymerization, in particular when EB drying is utilized.

Preferably, the further drying of the MFC film of the laminate is performed by applying heat or radiation on the side of the laminate comprising the MFC film. For example, the moisture content of the MFC film of the laminate may be measured, e.g., on-line, by a spectroscopic method, such as an infrared moisture sensor based on a typical single-sided infrared gauge which is mounted in a single head package, with for example a halogen source focused on the sheet. Part of the beam is absorbed and part is reflected (scattered) back, collected and detected. Thus, the moisture content of the MFC film is then measured from the MFC side of the laminate. The moisture content may be determined at ambient conditions. Alternatively, the dry content of the MFC film may be measured and the dry content utilized for determining the moisture content.

For example, the moisture content of the paper or paperboard substrate of the laminate after the further drying of the MFC film may be 2-9 weight-%, preferably 3-8 weight-%, more preferably 3-7 weight-% or 3-6 weight-%. The moisture content of the paper or paperboard substrate may be determined by determining the dry content according to ISO 638 and calculating moisture content or by using spectroscopic methods.

In some embodiments, the step of providing the first web comprises providing a first reel of the first web and unwinding the first web from the first reel. Thus, in these embodiments, the unwound first web is joined with the second web.

In some embodiments, the step of providing the second web comprises providing a second reel of the second web of the MFC film and unwinding the second web from the second reel. In these embodiments, the MFC film of the unwound second web is joined with the first web.

In some embodiments, the method of the first aspect comprises the steps of:
providing a first reel of a first web comprising a paper or paperboard substrate and unwinding the first web from the first reel;
providing a second reel of a second web of an MFC film, wherein the MFC film has: a) a content of MFC of between 50 and 100 weight-% based on total dry weight; b) a moisture content of 5-20 weight-%, preferably 5-15 weight-%, and c) a ratio of a machine direction tensile index and a cross direction tensile index of 0.8-1.4, preferably 0.8-1.2, most preferably 0.9-1.1, and unwinding the second web from the second reel;
joining the unwound first web and the unwound second web using at least one adhesive layer provided between the first web and the second web so as to form the laminate, and
further drying of the MFC film of the laminate to a moisture content of less than 4 weight-%, preferably less than 2 weight-%, most preferably less than 1.5 weight-%.

In some embodiments, the method is an in-line or continuous process with the production of the MFC film, wherein the step of providing the second web of the MFC film comprises providing the second web of the MFC film directly from the production of the MFC film, i.e., without winding of the MFC film onto any reel. Thus, in these embodiments, the step of providing the second web of the MFC film may comprise forming a wet MFC film of an MFC suspension by casting on a non-porous support, dewatering and/or drying the wet MFC film on the non-porous support to provide the MFC film having a moisture content of 5-20 weight-%, and peeling off the MFC film from the non-porous support such that a web (i.e., the second web) of the MFC film having a moisture content of 5-20 weight-% is provided.

There is a demand for improved solutions to replace aluminum foils and barrier plastic layers, such as polyolefin films, as barrier layers and substrates in packaging materials with alternatives that facilitate re-pulping and recycling of the used packaging materials. The laminate according to the present disclosure can advantageously be manufactured almost entirely from biobased materials, and preferably from cellulose based materials, thereby facilitating re-pulping and recycling of used packaging materials comprising the laminate according to the present disclosure.

The laminate according to the present disclosure can provide an alternative to conventional materials using barrier plastic layers, such as polyolefin films, and/or aluminum foil layers, which can more readily be repulped and recycled. In some embodiments, the laminate has a reject rate according to PTS RH 021/97 of less than 30%, preferably less than 20%, more preferably less than 10%, most preferably less than 5%. The laminate according to the present disclosure may provide at least a reduction of the use of barrier plastic layers and/or aluminum foil layers as used in conventional materials.

However, the laminate of the present disclosure may further be provided with an outermost polymer layer on one side or on both sides. The outermost polymer layers preferably provide liquid barrier properties and mechanical protection, such as print protection, for the laminate surface(s). The outermost polymer layer is preferably also heat-sealable.

In some embodiments, the method of the first aspect further comprises a step of providing the laminate with an outermost first polymer layer on the MFC film, wherein the further drying of the MFC film of the laminate is performed before the step of providing the laminate with an outermost first polymer layer. In some embodiments, the outermost first polymer layer comprises a thermoplastic polymer. In some embodiments, the outermost first polymer layer comprises a polymer selected from the group consisting of polyolefins and polyesters. In some embodiments, the outermost first polymer layer comprises a polymer selected from the group consisting of thermoplastic polyolefins and thermoplastic polyesters. In some embodiments, the outermost first polymer layer comprises polypropylene or polyethylene. In some embodiments, the outermost first polymer layer comprises polyethylene, more preferably LDPE or HDPE. By performing the further drying of the MFC film of the laminate before the step of providing the laminate with an outermost first polymer layer, the moisture trapped between the adhesive layer (tie layer) and the outermost first polymer layer is reduced.

In some embodiments, the method of the first aspect further comprises a step of providing the laminate with an outermost second polymer layer on the paper or paperboard substrate, wherein the further drying of the MFC film of the laminate is performed before the step of providing the laminate with an outermost second polymer layer. In some embodiments, the outermost second polymer layer comprises a thermoplastic polymer. In some embodiments, the outermost second polymer layer comprises a polymer selected from the group consisting of polyolefins and polyesters. In some embodiments, the outermost second polymer layer comprises a polymer selected from the group consisting of thermoplastic polyolefins and thermoplastic polyesters. In some embodiments, the outermost second polymer layer comprises polypropylene or polyethylene. In some embodiments, the outermost second polymer layer comprises polyethylene, more preferably LDPE or HDPE.

The outermost first polymer layer and the outermost second polymer layer, respectively, may comprise any of the thermoplastic polymers commonly used in protective and/or heat-sealable layers in paper or paperboard based packaging laminates in general or polymers used in liquid or food packaging board in particular. Examples include polyethylene (PE), polyethylene terephthalate (PET), polyethylene furanoate (PEF), polypropylene (PP), polyhydroxyalkanoates (PHA), polylactic acid (PLA), polyglycolic acid (PGA), starch and cellulose. Polyethylenes, especially low density polyethylene (LDPE) and high density polyethylene (HDPE), are the most common and versatile polymers used in liquid or food packaging board. The polymers used are preferably manufactured from renewable materials. The outermost first polymer layer and the outermost second polymer layer may comprise the same or different polymers.

The outermost polymer layers may of course interfere with repulpability but may still be required or desired in some applications. The outermost first polymer layer and/or the outermost second polymer layer may, for example, be applied by extrusion coating, film lamination (i.e., lamination of a solid film) or dispersion coating. Thermoplastic polymers are useful since they can be conveniently processed by extrusion coating techniques to form very thin and homogenous films with good liquid barrier properties.

In some embodiments, the outermost polymer layers are formed by extrusion coating of the polymer onto the laminate. Extrusion coating is a process by which a molten plastic material is applied to a substrate to form a very thin, smooth uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

The basis weight of each of the outermost polymer layers is preferably less than 50 g/m². In order to achieve a continuous and substantially defect free film, a basis weight of each of the outermost polymer layers of at least 6 g/m², preferably at least 8 g/m² or at least 12 g/m² is typically required if provided by extrusion coating. In some embodiments, the basis weight of each of the outermost polymer layers is in the range of 6-50 g/m², preferably in the range of 8-50 g/m² or 10-25 g/m² or 10-20 g/m², wherein the outermost polymer layers are provided by extrusion coating. In some embodiments, the basis weight of each of the outermost polymer layers is in the range of 2-10 g/m², wherein the outermost polymer layers are provided by foamed film.

According to a second aspect of the present disclosure there is provided a laminate comprising a paper or paperboard substrate and an MFC film joined with at least one adhesive layer provided between the paper or paperboard substrate and the MFC film, which laminate is obtainable by the method of the first aspect.

The laminate obtainable by the method of the first aspect can be used as such. Alternatively, it can be combined with one or more further layers, such as one or more further paper or paperboard layers and/or other layers, into a laminated material. When the laminate is combined with one or more further layers, such as one or more paper or paperboard layers, into a laminated material, the laminated material may optionally be provided with an outermost polymer layer (corresponding to the outermost polymer layer described above) on one side or on both sides. Other examples of further layers that may be combined with the laminate obtainable by the method of the first aspect are further polymer layers such that there are multiple polymer layers of same or different polymers on each side, a protective varnish layer, a décor layer on top of the laminate, and a sealing layer that can be activated (molten) with heat.

For example, the laminate or laminated material can be used as a packaging material or in a packaging material, such as a food or liquid packaging material. For example, the laminate or laminated material can be part of a flexible packaging material, such as a free-standing pouch or bag, which may be opaque or translucent. Thus, the laminate or laminated material may be used as bag material in boxes when packaging dry food such as cereals. Furthermore, the laminate or laminated material may be used as a wrapping substrate, such as a flow wrap material, as a laminate material in paper, paperboard or plastics and/or as a substrate for disposable electronics. The laminate or laminated material may also be included in for example a closure, a lid or a label. The laminate or laminated material can be incorporated into any type of package, such as a box, bag, wrap, wrapping film, cup, container, tray, bottle, etc. The present disclosure also relates to a packaging product comprising the laminate or laminated material obtainable by the method of the first aspect.

The laminate produced by the method of the first aspect is a paper or paperboard based laminate, i.e., a laminate formed mainly from paper or paperboard, such as a paper or paperboard based packaging laminate. The laminate has typically a first outermost surface which may be intended to serve as the outside surface, or print side, and a second outermost surface which may be intended to serve as the inside surface of a packaging container. The side of the paper or paperboard substrate comprising the MFC film may be intended to serve as the inside surface of a packaging container.

In some embodiments, when 10 or 15 g/m² LDPE is used as laminating adhesive, 10 or 15 g/m² LDPE as coating on the side of the MFC film (back side), 20 g/m² as coating on the other side (top side), and a liquid packaging board as paper substrate, the produced laminate has an oxygen transmission rate below 1 cc/m²/day in 23° C. and 50% relative humidity (RH) and below 10 cc/m2/day, such as 0.1-5 cc/m²/day or 5-10 cc/m²/day in 23° C. and 80% RH according to the standard ASTM F1927-20. The produced laminate has a water vapor transmission rate below 1 g/m²/day in 23° C. and 50% RH and below 10 g/m²/day, such as 0.1-5 g/m²/day or 5-10 g/m²/day in 38° C. and 85% RH according to the standard ASTM F1249-20.

Some examples of possible structures of the laminate according to the present disclosure are shown below:
A/B/C
D/A/B/C
A/B/C/D
D/A/B/C/D
D/A/B/C/D/D
D/D/A/B/C/D/D
   wherein A is paper substrate or paperboard substrate, B is tie layer (adhesive layer), C is MFC film and D is sealing and/or liquid barrier such as polyolefin,

Generally, while the products, materials, layers and processes are described in terms of “comprising” various components or steps, the products, materials, layers and processes can also “consist essentially of” or “consist of” the various components and steps.

In view of the above detailed description of the present invention, other modifications and variations will become apparent to those skilled in the art. However, it should be apparent that such other modifications and variations may be effected without departing from the spirit and scope of the invention.

1. A method for producing a laminate comprising a paper or paperboard substrate and a microfibrillated cellulose (MFC) film, wherein the method comprises the steps of:
providing a first web comprising a paper or paperboard substrate;
providing a second web of an MFC film, wherein the MFC film has: a) a content of MFC of between 50 and 100 weight-% based on a total dry weight; b) a moisture content of 5-20 weight-%; and, c) a ratio of a machine direction tensile index and a cross direction tensile index of 0.8-1.4;
joining said first web and said second web using at least one adhesive layer provided between said first web and said second web so as to form said laminate, and
drying of said MFC film of said laminate to a moisture content of less than 4 weight-%.

2. The method according to claim 1, wherein said step of providing said first web comprises providing a first reel of said first web and unwinding said first web from said first reel.

3. The method according to claim 1, wherein said step of providing said second web comprises providing a second reel of said second web and unwinding said second web from said second reel.

4. The method according to claim 1, wherein said step of further drying of said MFC film of said laminate is performed by applying heat or radiation on a side of the laminate comprising the MFC film.

5. The method according to claim 1, wherein said further-drying of said MFC film of said laminate is selected from a group consisting of: contact drying, infrared drying, near infrared drying, microwave drying, ultraviolet drying, electron beam drying, hot gas impingement drying, radiation drying, and a combination thereof.

6. (canceled)

7. The method according to claim 1, wherein the method further comprises a step of:
providing the laminate with an outermost first polymer layer on the MFC film, wherein said drying of said MFC film of said laminate is performed before the step of providing the laminate with an outermost first polymer layer.

8. (canceled)

9. (canceled)

10. (canceled)

11. The method according to claim 1, wherein the method further comprises a step of:
providing the laminate with an outermost second polymer layer on the paper or paperboard substrate, wherein said drying of said MFC film of said laminate is performed before the step of providing the laminate with an outermost second polymer layer.

12. (canceled)

13. (canceled)

14. (canceled)

15. The method according to claim 1, wherein said MFC film has a content of MFC of between 70 and 100 weight-% based on the total dry weight.

16. The method according to claim 1, wherein said MFC film has a dry grammage of 4-80 g/m².

17. The method according to claim 1, wherein said MFC film comprises at least one cross-linking agent.

18. The method according to claim 1, wherein said MFC film has a tensile index in a machine direction of at least 20 Nm/g.

19. The method according to claim 1, wherein said MFC film has a strain at break in a machine direction of at least 1.5%.

20. The method according to claim 1, wherein at least one adhesive layer of said at least one adhesive layer is provided on a surface of said first web before said step of joining.

21. The method according to claim 1, wherein at least one adhesive layer of said at least one adhesive layer is provided on a surface of said second web before said step of joining.

22. The method according to claim 1, wherein said step of joining comprises joining said first web and said second web using said at least one adhesive layer in a lamination station comprising at least one lamination nip.

23. The method according to claim 1, wherein said step of joining comprises joining said first web and said second web in a lamination station comprising a lamination nip and wherein at least one of said at least one adhesive layer is formed and provided between said first web and said second web in said lamination nip.

24. The method according to claim 1, wherein said adhesive layer comprises at least 50 weight-% of an adhesive polymer or mixture of adhesive polymers based on a dry weight.

25. The method according to claim 24, wherein said adhesive layer comprises one or more adhesive polymers selected from a group consisting of: polyolefins, polyesters, polyurethanes, and acrylic copolymers.

26. The method according to claim 1, wherein said adhesive layer comprises at least 50 weight-% of a water-soluble polymer or mixture of water-soluble polymers based on a dry weight.

27. A laminate comprising a paper or paperboard substrate and a microfibrillated cellulose (MFC) film, obtained by the method as claimed in claim 1.

28. A packaging material comprising the laminate according to claim 27.

29. (canceled)
